(19) United States
(12) Patent Application Publication
(10) Pub. No.: US 2021/0144902 A1
(43) Pub. Date: May 20, 2021

(54) SYSTEMS AND METHODS OF WORKING A FIELD AND DETERMINING A LOCATION OF IMPLEMENTS WITHIN A FIELD

(71) Applicant: PRECISION PLANTING LLC, Tremont, IL (US)

(72) Inventor: Ryan ALLGAIER, Tremont, IL (US)

(73) Assignee: Precision Planting LLC, Tremont, IL (US)

(21) Appl. No.: 17/044,107

(22) PCT Filed: Jun. 17, 2019
(86) PCT No.: PCT/IB2019/055021

§ 371 Date: Sep. 30, 2020

Related U.S. Application Data
(60) Provisional application No. 62/700,276, filed on Jul. 18, 2018.

(51) Int. Cl. A01B 69/04; B60W 30/10; A01B 69/00; A01B 79/00

(52) U.S. Cl. CPC A01B 69/008; B60W 30/10; A01B 69/004; A01B 79/005; B60W 2300/152; B60W 2756/10; B60W 2520/14; B60W 2520/16; B60W 2520/18; B60W 2556/60; B60W 2710/20; B60W 2420/42

(57) ABSTRACT

A method of working a field includes receiving a plurality of signals from satellites at a global positioning system (GPS) receiver carried by a tractor; determining a location within a field of the GPS receiver based on the signals from the satellites; and determining an orientation with respect to the tractor of an implement towed by the tractor. The implement includes a toolbar and a hitch, and the hitch is coupled to a drawbar of the tractor. The method further includes determining, based at least in part on the location of the GPS receiver and the orientation of the implement, a location within the field of at least one point on the implement in addition to a location of the hitch; and steering the tractor to direct the implement along a selected path previously traversed by another implement within the field.

### CROSS-REFERENCE TO RELATED APPLICATIONS

This application claims priority to U.S. Provisional Patent Application 62/700,276, “System and Method for Determining Absolute Position of an Implement and Its Components for Precise Guidance,” filed Jul. 18, 2018, the disclosure of which is hereby incorporated herein in its entirety by this reference.

### FIELD

Embodiments of the present disclosure relate generally to methods and systems for working an agricultural field. In particular, the methods and systems may be useful for precisely locating implements within the field.

### BACKGROUND

Accurate guidance of agricultural implements during field operations is becoming increasingly important as the size of agricultural implements continues to increase to meet the demand of growers wanting more productivity from their equipment. As an example, the John Deere DB120 planter has a 120-foot toolbar with 48 rows on 30-inch spacing and is capable of planting 90 to 100 acres per hour. Growers operating such large equipment rely on Global Navigation Satellite Systems (GNSS) and automated steering to ensure each planting pass is properly spaced and aligned with the preceding planting pass. Ensuring proper spacing between planter passes makes subsequent field operations (e.g., fertilizer application, harvesting, etc.) easier to perform and minimizes or avoids crop damage due to inadvertently running over crop rows that are inconsistently spaced or not aligned with adjacent crop rows.

In conventional guidance systems, a tractor's GNSS unit tracks its location within the field. An automated steering system utilizes the GNSS unit's location tracking to guide the tractor across the field along the desired path selected by the operator. While conventional GNSS and automated steering systems (collectively “guidance systems”) are generally adequate for many field operations, such conventional guidance systems are inadequate for certain field operations in which two subsequent field operations performed with different implements process each row at the exact same location.

One example in which each row is processed at the exact same location utilizing different implements in separate passes is with strip till applications—the first pass is made with a strip till implement and a subsequent pass is made with a planter implement. Whether in strip till applications or other applications in which each row is processed at the exact same location utilizing different implements in separate passes, operators can try to rely on sight by continuously looking rearward to try to keep the second pass implement aligned with the first pass implement (which is difficult at best, particularly for larger implements), or the operator must rely on a guidance system (i.e., GNSS coordinates and auto-steering). While guidance systems are generally more accurate and reliable than trying to rely solely on sight to keep the separate implement passes aligned, different implements have different geometries and thus each implement drawn by the tractor must be guided and maneuvered through the field based on that implement's unique geometry.

There are systems available on the market that utilize concepts such as tractrix that attempt to predict the location of the implement given the known position of the tractor in the field, the path that the tractor took to reach its current location in the field, and inputs of the geometries of the tractor and implement. However, such systems assume zero external forces like friction or drag and implement drift which can introduce inaccuracies in the implement prediction model. While the inaccuracies or errors may be canceled out pass-to-pass when using the same implement, the errors may be different in subsequent passes with a different implement that introduces different inaccuracies due to its different geometries or characteristics. Thus, such systems are not acceptable for making control decisions about where to steer the tractor to ensure different implements are maintained along the proper path through the field to ensure that each row is processed at the exact same location.

Others in the industry have attempted to measure the implement position during field operations to account for the external forces that can introduce inaccuracies in the actual position of the implement relative to the tractor drawing the implement in order to predict the future path of the implement so steering adjustments can be made to the tractor to ensure the implement is guided along the proper path. One such system is the Trimble TrueGuide™ system which utilizes multiple GNSS receivers (i.e., one on the tractor and one on the implement) to enable the autosteer software in the tractor to predict the future path of the implement to in order to steer the tractor to ensure the implement follows the intended path. However, such systems are expensive in that they require multiple, high-resolution GNSS receivers to accomplish the proper implement guidance.

Accordingly, there remains a need for a guidance system for measuring the implement position within the field and which does not require the expense associated with systems that rely on multiple GNSS receivers to measure the implement in the field with respect to the tractor.

### BRIEF SUMMARY

In some embodiments, a method of working a field includes receiving a plurality of signals from satellites at a global positioning system (GPS) receiver carried by a tractor; determining a location within a field of the GPS receiver based on the signals from the satellites; and determining an orientation with respect to the tractor of an implement towed by the tractor. The implement includes a toolbar and a hitch, and the hitch is coupled to a drawbar of the tractor. The method further includes determining, based at least in part on the location of the GPS receiver and the orientation of the implement, a location within the field of at least one point on the implement in addition to a location of the hitch; and steering the tractor to direct the implement along a selected path previously traversed by another implement within the field.

In other embodiments, a non-transitory computer-readable storage medium includes instructions that when executed by a computer, cause the computer to receive a plurality of signals from satellites at a global positioning system (GPS) receiver carried by a tractor; determine a location within a field of the GPS receiver based on the signals from the satellites; determine an orientation with respect to the tractor of an implement towed by the tractor. The implement includes a toolbar and a hitch, and the hitch is configured to be coupled to a drawbar of the tractor. The instructions further cause the computer to determine, based at least in part on the location of the GPS receiver and the orientation of the implement, a location within the field of at least one point on the implement in addition to a location of the hitch; and steer the tractor to direct the implement along a selected path previously traversed by another implement within the field.

In some embodiments, a system for determining a location of an implement includes a tractor having a drawbar; an implement comprising a toolbar and a hitch, the hitch coupled to the drawbar such that the implement is configured to rotate about a connection between the hitch and the drawbar when the implement is pulled by the tractor; a GPS receiver carried by the tractor or the implement; at least one camera configured to detect a position of the implement relative to the tractor; and a monitor in signal connection with the GPS receiver and the at least one camera. The monitor is configured to determine a location within a field of at least one point on the implement.

### BRIEF DESCRIPTION OF THE DRAWINGS

FIG. 1 is a top plan view of a tractor drawing a first implement through a field.

FIG. 2 is a top plan view of a tractor drawing a second implement through a field.

FIG. 3 is an example of an embodiment of row unit of the first implement.

FIG. 4 is an example of an embodiment of a row unit of the second implement.

FIG. 5 schematically illustrates tractor measurement inputs for defining the position of the tractor drawbar connection point relative to the tractor GPS receiver.

FIG. 6 schematically illustrates implement measurement inputs for defining the position of certain of the first implement's components relative to the first implement's hitch connection point.

FIG. 7 schematically illustrates implement measurement inputs for defining the position of certain of the second implement's components relative to the second implement's hitch connection point.

FIG. 8 is a schematic representation of one method of measuring the implement position within the field utilizing a 3-axis magnetometer or gyroscope disposed on the tractor and a 3-axis magnetometer or gyroscope disposed on the implement for determining the Euler angles of the implement relative to the tractor.

FIG. 9 is a schematic representation of another method of measuring the implement position within the field utilizing an ultra-wideband position system to determine the position of the implement relative to the tractor.

FIG. 10 is a schematic representation of another method of measuring the implement position within the field utilizing 3-axis position sensor at the hitch.

FIGS. 11A and 11B are schematic representations of another method of measuring the implement position within the field utilizing cameras to measure the implement position relative to the tractor.

### DETAILED DESCRIPTION

The illustrations presented herein are not actual views of any particular tractor or implement, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

All references cited herein are incorporated herein in their entireties. If there is a conflict between definitions herein and in an incorporated reference, the definition herein shall control.

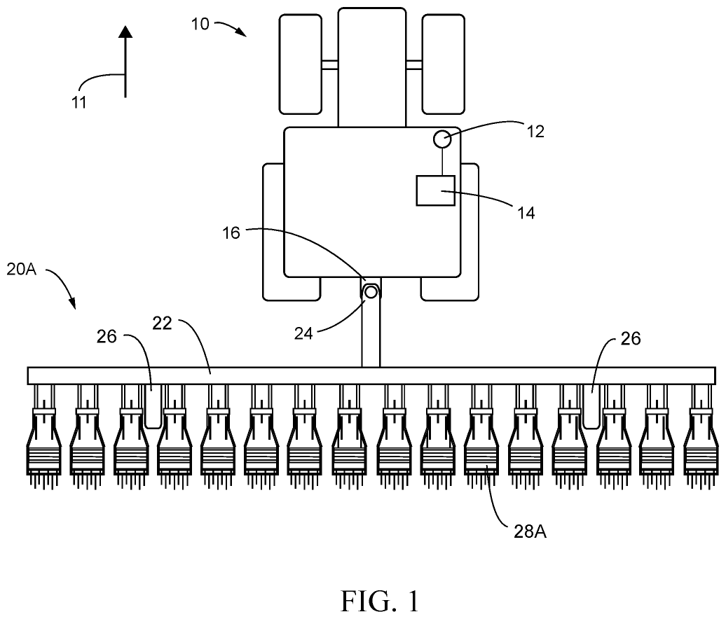

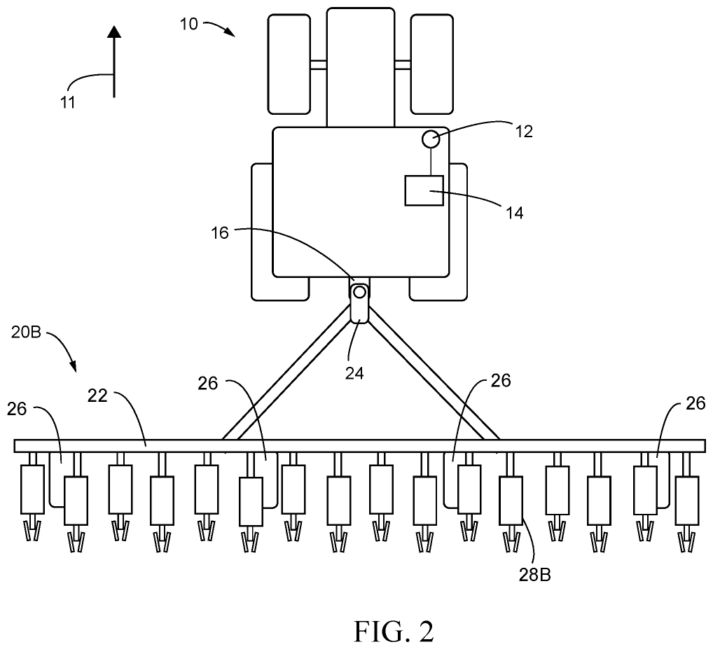

Referring now to the drawings, wherein like reference numbers designate the same or corresponding parts, FIG. 1 is a top plan view of an embodiment of a tractor 10 drawing a first implement 20A (shown as a strip till implement) in a forward direction of travel indicated by arrow 11. FIG. 2 is a top plan view of an embodiment of a tractor 10 drawing a second implement 20B (shown as a row planter) in a forward direction of travel indicated by arrow 11. For purposes of this description, the embodiments of the first and second implements 20A, 20B are provided by way of example only for the purpose of identifying two different implements that may be guided to process each row at the exact same location in subsequent passes of a field to which the apparatus, systems, and methods described herein are particularly well suited. However, the apparatus, systems, and methods described herein may be used for guiding any implement during a field operation. Thus, reference numeral 20 is used to identify an implement generally, when describing the apparatus, systems, and methods throughout this specification when not referring to the particular strip till implement 20A or row planter implement 20B.

The tractor 10 includes a GNSS or GPS receiver 12 in signal communication with a monitor 14. The monitor 14 may include a central processing unit (“CPU”), memory, and a graphical user interface (“GUI”) allowing the user to view and enter data into the monitor. An example of a suitable monitor is disclosed in U.S. Pat. No. 8,386,137, “Planter Monitor System and Method,” issued Feb. 26, 2013.

The implement 20 includes a toolbar 22 that is connected by a hitch 24 to the tractor's drawbar 16. The toolbar 22 is supported by wheel assemblies 26 adapted to raise and lower the toolbar 22 with respect to the soil surface between an operating position and a travel position. The toolbar 22 supports a plurality of row units. For the strip till implement 20A, the row units are designated by reference number 28A. For the row planter implement 20B, the row units are designated by reference number 28B. It should be appreciated that the components and configurations that make up the row units may vary depending on the implement. Thus, reference numeral 28 is used to identify a row unit generally, when describing the apparatus, systems, and methods throughout this specification when not referring to the particular strip till implement 20A or row planter implement 20B.

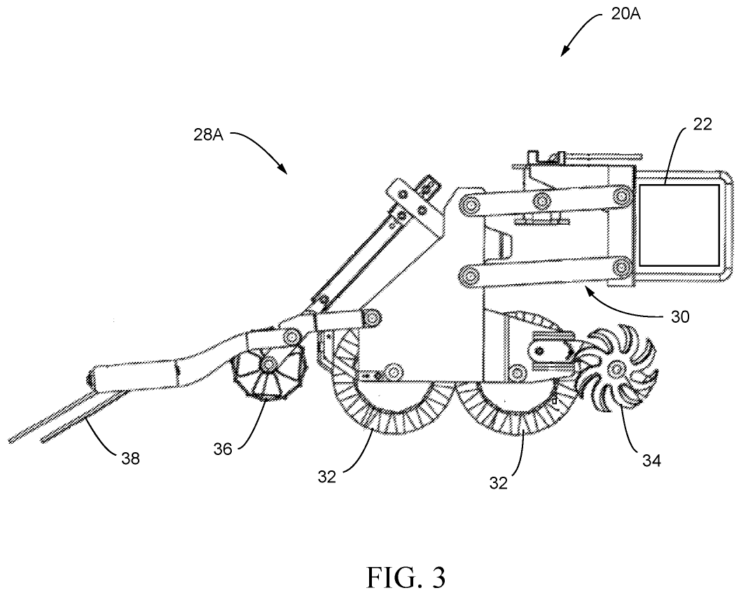

FIG. 3 is an example of an embodiment of a strip till row unit 28A, such as disclosed in U.S. Pat. No. 9,363,938, “Strip-Till Row Apparatus,” issued Jun. 14, 2016. Another example of a commercially available implement with strip till row units is the Nutri-Tiller™ manufactured by CNH Industrial N.V., of London, U.K. The strip till row unit 28A is shown mounted to the toolbar 22 via a parallel linkage 30 that allows the individual row units 28A to move vertically independently with respect to one another and with respect to the toolbar 22 in the event the row unit 28A encounters an obstruction, such as a rock, while the implement 20A traverses the field. The row unit 28A may include various tillage tools, such as laterally and longitudinally spaced coulters 32, row cleaners 34, a rolling basket 36, and a harrow assembly 38 as shown. Additionally or alternatively, the row unit 28A may include other tillage tools, such as points, tines, shovels, etc. as well known in the art, such as disclosed in International Patent Publication WO2016/099386 A1, “Method of Controlling an Agricultural Implement and an Agricultural Implement,” published Jun. 23, 2016.

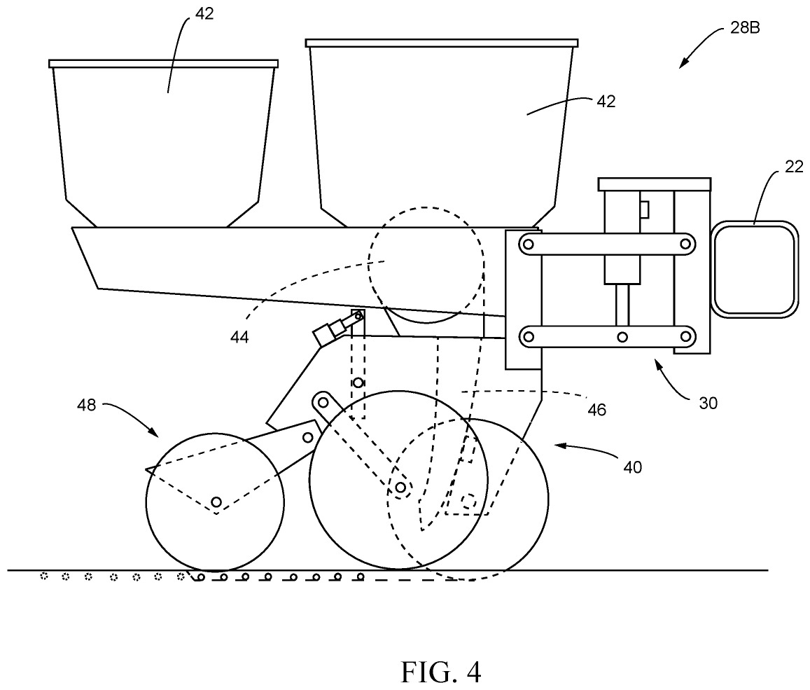

FIG. 4 is an example of an embodiment of a conventional planter row unit 28B. Another embodiment of a commercially available planter row unit is the Ready Row Unit™ available from Precision Planting LLC, of Tremont, Ill. The planter row unit 28B is shown mounted to the toolbar 22 via a parallel linkage 30 that allows the individual row units 28B to move vertically independently with respect to one another and with respect to the toolbar 22 in the event the row unit 28B encounters an obstruction, such as a rock, while the implement 20B traverses the field. The planter row unit 28B may include a furrow opening assembly 40 to open a seed furrow in the strip-tilled soil prepared by the strip till implement 20A in a preceding pass through the field. Each planter row unit 28B also include one or more hoppers 42 holding seed or fertilizer, a seed meter 44 that singulates the seeds communicated from the seed hopper 42, a seed tube or seed conveyor 46 for directing the singulated seeds to the seed furrow, and a closing assembly 48 for closing the seed furrow with soil after the seeds are deposited into the furrow. Adjacent row units 28B may be staggered or longitudinally offset as shown in FIG. 2 to accommodate narrower row spacings. The planter row unit 28B may also be adapted with mini-hoppers for use with a central-fill planters as well known in the art, or alternatively the row unit 28B may be configured as an air seeder row unit, as is well known in the art.

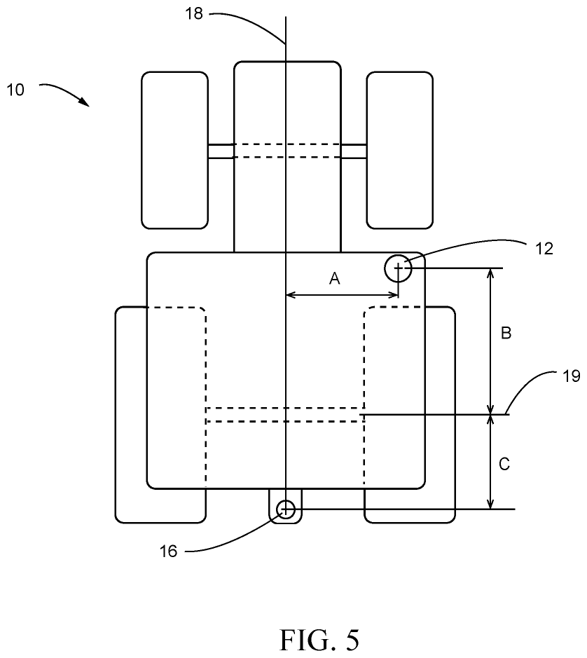

FIG. 5 schematically illustrates tractor measurements which may be input into the monitor 14 via the GUI for defining the position of the connection point of the tractor's drawbar 16 relative to the tractor GPS receiver 12. By way of example, dimension A is the distance from the GNSS/GPS receiver 12 to the central longitudinal axis 18 of the tractor 10. Dimension B is the distance from the GNSS/GPS receiver 12 to the centerline of the rear axle 19. Dimension C is the distance from the centerline of the rear axle 19 to the center of the pin or connection point of the tractor's drawbar 16. Additional or alternative tractor dimensions may also be input via the GUI or any other device (e.g., by removable media, by a wired or wireless network, etc.).

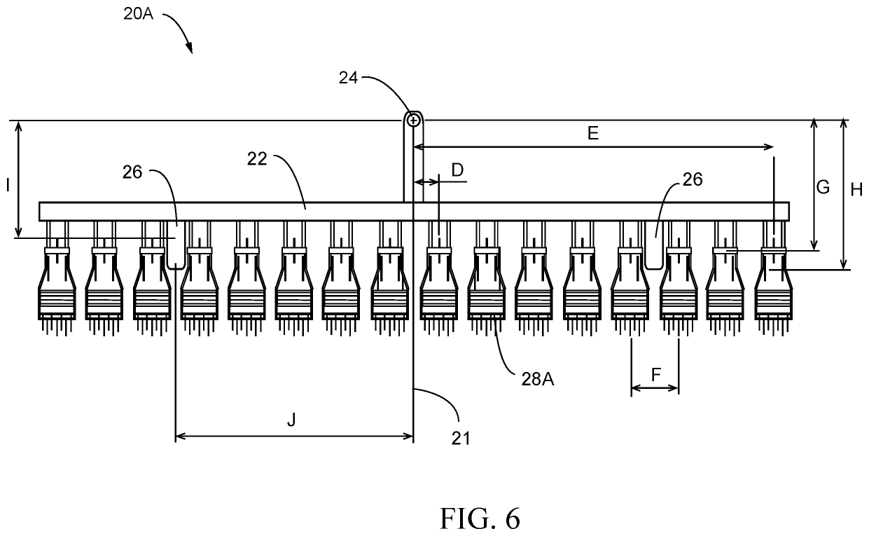

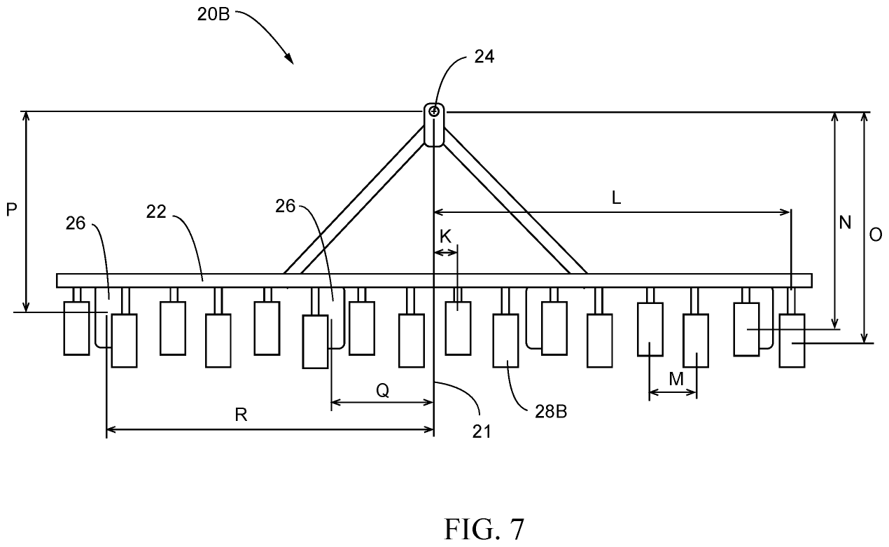

FIGS. 6 and 7 schematically illustrate implement measurements that may be input into the monitor 14 via the GUI or another device for defining the position of certain implement components relative to the implement's hitch connection point. By way of example, with respect to the strip till implement 20A (FIG. 6), dimension D is the lateral distance from the longitudinal axis 21 of the implement 20A to the nearest adjacent row unit 28A. Dimension E is the lateral distance from the longitudinal axis 21 of the implement 20A to the outermost row unit 28A. Dimension F is the lateral spacing of the row units 28A. Dimension G is the longitudinal distance from the center of the pin of the implement hitch 24 to one of the tillage tools, e.g., first coulter 32, of the row unit 28A. Dimension H may be the longitudinal distance from the center of the pin of the implement hitch 24 to another tillage tool 32, 36, 38 of the row unit 28A. Dimension I is the longitudinal distance from the center of the pin of the implement hitch 24 to the centerline of the axle of the wheel assembly 26. Dimensions J is the lateral distance from the longitudinal axis 21 of the implement 20A to the centerline of the wheel assembly 26. Additional or alternative implement dimensions may also be input via the GUI or another device. Referring to FIG. 7, by way of example, with respect to the planter implement 20B, dimension K is the lateral distance from the longitudinal axis 21 of the implement 20B to the nearest adjacent row unit 28B. Dimension L is the lateral distance from the longitudinal axis 21 of the implement 20B to the outermost row unit 28B. Dimension M is the lateral spacing of the row units 28B. Dimension N is the longitudinal distance from the center of the pin of the implement hitch 24 to a seed tube outlet of one of the forward staggered row units 28B. Dimension O may be the longitudinal distance from the center of the pin of the implement hitch 24 to the seed tube outlet of the rearward staggered row unit 28B. Dimension P is the longitudinal distance from the center of the pin of the implement hitch 24 to the centerline of the axle of the wheel assembly 26. Dimensions Q and R are the lateral distances from the longitudinal axis 21 of the implement 20B to the centerline of the wheel assemblies 26. Additional or alternative implement dimensions may also be input via the GUI or another device.

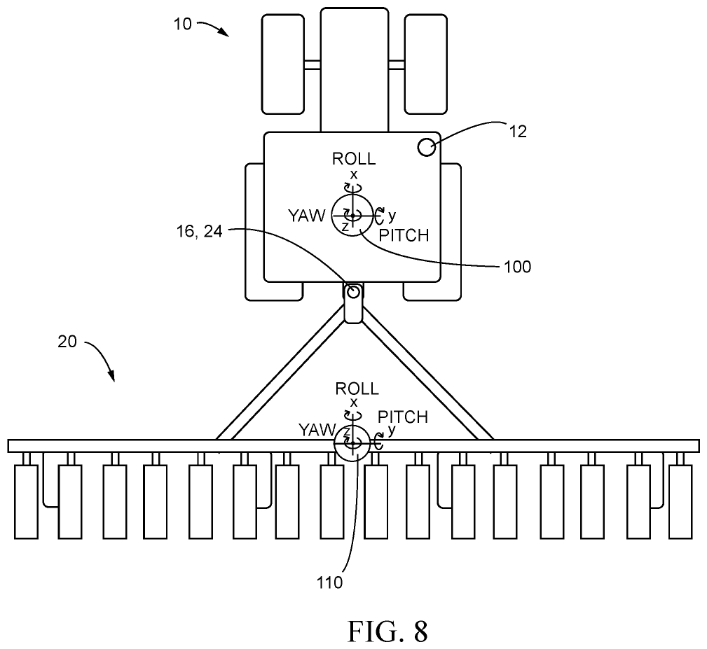

FIG. 8 depicts a 3-axis magnetometer or 3-axis gyroscope 100 mounted to tractor 10. Another 3-axis magnetometer or 3-axis gyroscope 110 is mounted to the implement 20. Suitable 3-axis magnetometer or 3-axis gyroscopes include the HMC2003 or HMR2300 magnetometers available from Honeywell Aerospace, of Phoenix, Ariz., the LIS3MDL magnetometer available from STMicroelectronics, of Geneva, Switzerland, the IAM-20380 gyroscope available from TDK, of Tokyo, Japan, or the FXAS21002C gyroscope available from NXP Semiconductors N.V., of Eindhoven, Netherlands. Such magnetometer or gyroscope sensors 100, 110 measure the Earth's magnetic flux or magnetic field in all three dimensions such that the vector from the center of the magnetometer or gyroscope 100, 110 to the Earth's poles can be measured with very high accuracy.

It should be appreciated that the coupling of the tractor drawbar 16 and implement hitch 24 provides a rigid coupling of the tractor 10 and the implement 20 in all translation axes (x, y, z), but permits movement in up to three degrees of freedom (yaw, pitch, and roll). It should also be appreciated that by defining the tractor hitch connection point 16 relative to the GNSS/GPS receiver, and by defining the implement component locations relative to the implement hitch connection point 24, the implement component positions are thereby defined relative to the tractor's GNSS/GPS receiver and the yaw, pitch, and roll from the magnetometer or gyroscope sensors 100, 110, such that the absolute coordinates of the implement components can be determined.

The 3-axis magnetometer/gyroscope sensor 100 on the tractor 10 measures the tractor's Euler angles (yaw, pitch, and roll), with respect to the Earth while the tractor's GNSS/GPS receiver 12 detects its global coordinates on the Earth. Simultaneously, the magnetometer/gyroscope sensor 110 on the implement 20 measures the implement's Euler angles (yaw, pitch, and roll) with respect to the Earth. As used herein, yaw refers to rotation about the sensor's Z-axis (i.e., the vertical axis of the sensor into and out of the page as viewed in FIG. 8). Pitch refers to rotation about the sensor's Y-axis (i.e., the axis perpendicular to the direction of travel). Roll refers to rotation about the sensor's X-axis (i.e., the axis parallel to the direction of travel). Thus, with the Euler angles of the tractor 10 being measured and the Euler angles of the implement 20 being measured by the sensors 100, 110, combined with the detected coordinates of the GNSS/GPS receiver 12 and the measured inputs of the tractor and implement, the absolute position of the tractor drawbar 16 and the absolute position of the implement's various components can be determined by geometric translation calculations. Once the absolute positions of the implement components are determined, the tractor's auto-steer computer system can perform the calculations necessary to steer the tractor 10 and implement 20 as needed to ensure the implement 20 is guided along the intended or desired path through the field, despite any differences that there may be in the geometry of the first and second implements 20A, 20B used in subsequent passes through the field, and while taking into account any external forces (drag, drift, etc.) affecting yaw, pitch or roll of the implement 20 while being guided through the field.

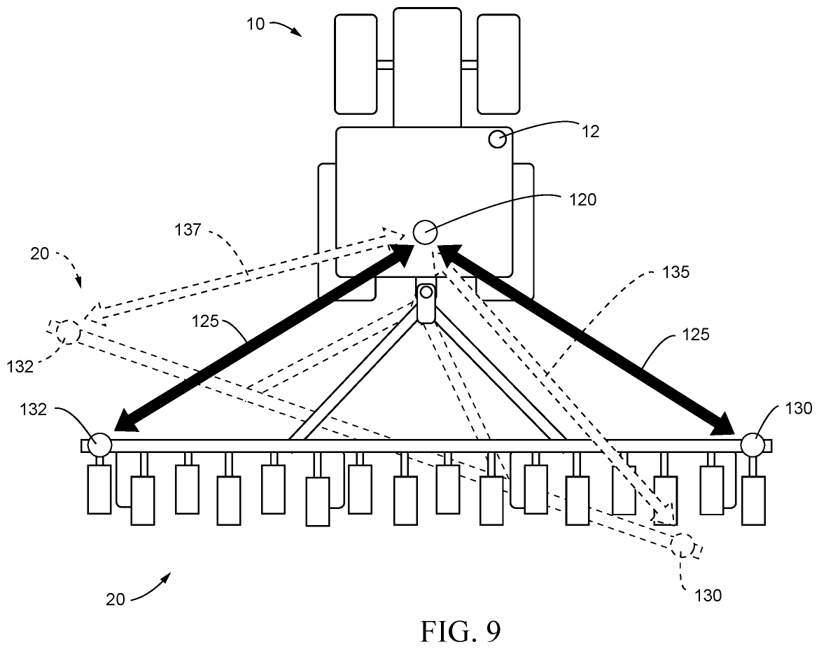

FIG. 9 illustrates another embodiment for measuring the position of the tractor 10 and implement 20. In this embodiment, one or more ultra-wideband (UWB) radio frequency (RF) transceivers 120 are disposed on the tractor 10 and one or more UWB RF transceivers 130, 132 are disposed on the implement 20. RF signals are transmitted and received by the transceivers 120, 130, 132. Time-of-flight (TOF) measurements are utilized to determine the distance between the transceivers 120 on the tractor 10 and the transceivers 130, 132 on the implement 20. It should be appreciated that if more transceivers are utilized, more degrees of freedom can be solved. For example, with two transceivers, distance can be determined. With three transceivers, distance and location on a plane can be determined. With four transceivers, location within a three-dimensional space can be determined.

As shown in FIG. 9, when the implement 20 is traveling straight with respect to the tractor 10 (i.e., in the same direction as the tractor 10), the TOF between the tractor transceiver 120 and the implement transceivers 130, 132 will be substantially the same, as indicated by black arrows 125. As the implement 20 moves relative to the tractor 10 due to drag or drift, as indicated by the implement 20 drawn in dashed lines, the TOF between the tractor transceiver 120 and the implement's right side transceiver 130 as viewed in FIG. 9 will have a longer TOF as indicated by dashed arrow 135 than the TOF between the tractor receiver 120 and the implement's left side transceiver 132 as indicated by dashed arrow 137. The TOF measurements combined with the coordinates of the GNSS/GPS receiver 12 and the tractor 10 and implement 20 measurement inputs (discussed above) can be used to determine the absolute position of the tractor drawbar 16 and the absolute position of the implement's various components based on geometric translation calculations. Once the absolute positions of the implement components are determined, the tractor's auto-steer computer system can perform the calculations necessary to steer the tractor and implement as needed to ensure the implement is guided along the intended or desired path through the field despite any differences that there may be in the geometry of the first and second implements 20A, 20B used in subsequent passes through the field, while taking into account any external forces (drag, drift, etc.) affecting yaw, pitch, or roll of the implement 20 being guided through the field.

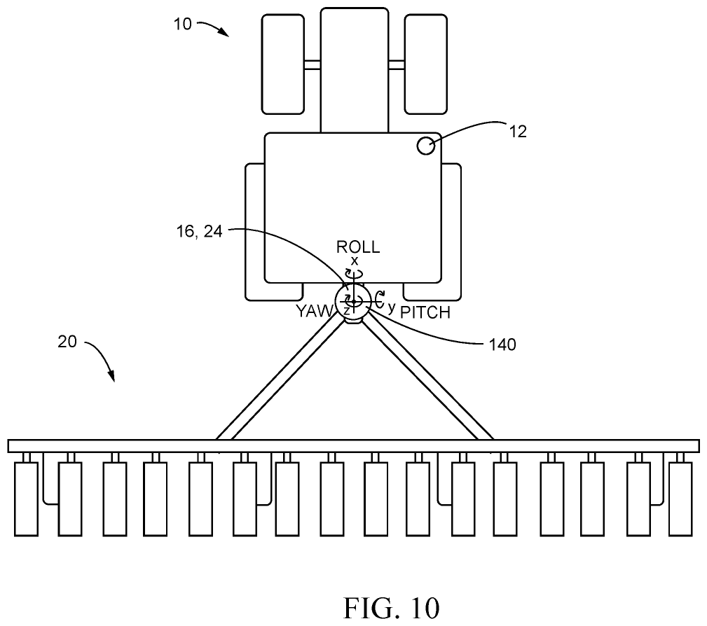

FIG. 10 illustrates another embodiment for measuring the position of the tractor 10 and implement 20. In this embodiment, one or more position sensors 140 are disposed on the tractor's drawbar 16 and implement's hitch 24 to measure yaw, pitch, and roll of the implement 20 relative to the tractor 10. The position sensors 140 may be contact rotary encoders configured to measure relative movement in each of the three X, Y, and Z axes, such as the AI25 CAN Open Encoder available from Dynapar, of Gurnee, Ill. Alternatively, non-contact inductive sensors may be provided to measure the position of a specially-shaped actuator such as the LDC1000 Inductance to Digital Converter available from Texas Instruments, of Dallas, Tex. Other non-contact encoders or contact rotary encoders are available from Dynapar, Omron Corporation (Kyoto, Japan), or Renishaw PLC (Wotton-under-Edge, Gloucestershire, UK).

With the yaw, pitch, and roll of the implement 20 with respect to the tractor 10 being determined by the position sensors 140, combined with the detected coordinates of the GNSS/GPS receiver 12 and the measured inputs of the tractor 10 and implement 20, the absolute position of the tractor hitch point 16 and the absolute position of the implement's various components can be determined by geometric translation calculations. Once the absolute positions of the implement components are determined, the tractor's auto-steer computer system can perform the calculations necessary to steer the tractor and implement as needed to ensure the implement is guided along the intended or desired path through the field despite any differences that there may be in the geometry of the first and second implements 20A, 20B used in subsequent passes through the field, and while taking into account any external forces (drag, drift, etc.) affecting yaw, pitch, or roll of the implement 20 while being guided through the field.

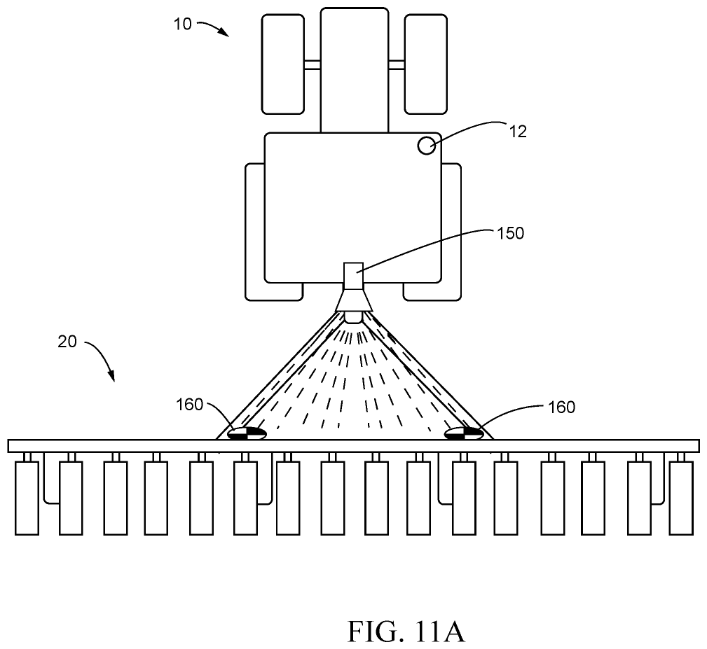

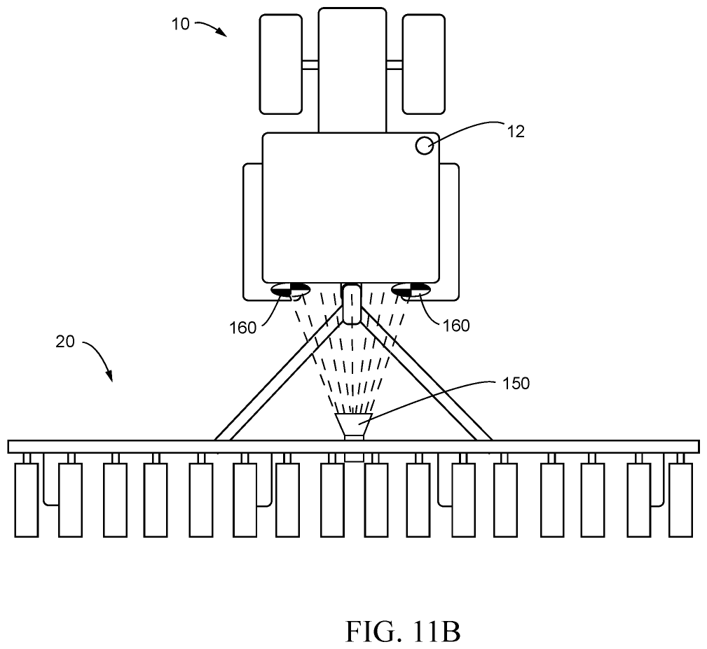

FIGS. 11A and 11B illustrate yet another embodiment for measuring the position of the tractor 10 and implement 20 utilizing a camera 150 and targets 160 to determine the relative location of the tractor 10 and implement 20. In FIG. 11A, the camera 150 is disposed on the tractor 10 and targets 160 are disposed on the implement 20. In FIG. 11B, the camera 150 is disposed on the implement 20 and the targets 160 are disposed on the tractor 10. The camera 150 measures its position relative to the targets 160 and transmits its position to the monitor 14. Suitable cameras 150 and targets 160 are available from Edmund Optics, of Barrington, N.J., and Allied Vision, of Exton, Pa.

With the relative position of the implement 20 with respect to the tractor 10 being determined via the camera 150 and targets 160, combined with the detected coordinates of the GNSS/GPS receiver 12 and the measured inputs of the tractor and implement, the absolute position of the tractor hitch point 16 and the absolute position of the implement's various components can be determined by geometric translation calculations. Once the absolute positions of the implement components are determined, the tractor's auto-steer computer system can perform the calculations necessary to steer the tractor and implement as needed to ensure the implement is guided along the intended or desired path through the field despite any differences that there may be in the geometry of the first and second implements 20A, 20B used in subsequent passes through the field, and while taking into account any external forces (drag, drift, etc.) affecting yaw, pitch, or roll of the implement while being guided through the field.

Different types of sensors may be used in any combination. In some embodiments, different sensors may be used to provide redundant information. In other embodiments, information from different sensors may be used together to locate the implements 20 within the field.

If a position/orientation of the implement 20 is not at a desired location, the position/orientation may be adjusted. Examples for adjusting the position/orientation of implement 20 can be found in International Patent Publication WO2018/218255A1, “Method to Prevent Drift of an Agricultural Implement,” published Nov. 29, 2018, or in International Patent Publication WO2016/099386A1.

Additional non limiting example embodiments of the disclosure are described below.

Embodiment 1: A method of working a field including receiving a plurality of signals from satellites at a global positioning system (GPS) receiver carried by a tractor; determining a location within a field of the GPS receiver based on the signals from the satellites; and determining an orientation with respect to the tractor of an implement towed by the tractor. The implement includes a toolbar and a hitch, and the hitch is coupled to a drawbar of the tractor. The method further includes determining, based at least in part on the location of the GPS receiver and the orientation of the implement, a location within the field of at least one point on the implement in addition to a location of the hitch; and steering the tractor to direct the implement along a selected path previously traversed by another implement within the field.

Embodiment 2: The method of Embodiment 1, further comprising determining, based at least in part on the location of the GPS receiver, a location within the field of a point at which the hitch pivots with respect to the drawbar.

Embodiment 3: The method of Embodiment 1 or Embodiment 2, wherein determining an orientation with respect to the tractor of an implement towed by the tractor comprises measuring Euler angles with respect to the Earth of each of the tractor and the implement.

Embodiment 4: The method of Embodiment 3, wherein measuring Euler angles with respect to the Earth of each of the tractor and the implement comprises measuring a yaw, pitch, and roll of each of the tractor and the implement.

Embodiment 5: The method of any one of Embodiment 1 through Embodiment 4, wherein determining an orientation with respect to the tractor of an implement towed by the tractor comprises measuring a distance from a point on the tractor to a point on the implement.

Embodiment 6: The method of Embodiment 5, wherein measuring a distance from a point on the tractor to a point on the implement comprises measuring a plurality of distances from a point on the tractor to a plurality of points on the implement.

Embodiment 7: The method of any one of Embodiment 1 through Embodiment 6, wherein determining an orientation with respect to the tractor of an implement towed by the tractor comprises measuring relative movement of the hitch with respect to the drawbar.

Embodiment 8: The method of Embodiment 7, wherein measuring relative movement of the hitch with respect to the drawbar comprises measuring rotary movement about three perpendicular axes.

Embodiment 9: The method of any one of Embodiment 1 through Embodiment 8, wherein determining an orientation with respect to the tractor of an implement towed by the tractor comprises capturing an image of a plurality of targets.

Embodiment 10: The method of Embodiment 9, wherein capturing an image of a plurality of targets comprises capturing, with a camera mounted at a fixed point with respect to the tractor, an image of a plurality of targets on the implement.

Embodiment 11: The method of Embodiment 9, wherein capturing an image of a plurality of targets comprises capturing, with a camera mounted at a fixed point with respect to the implement, an image of a plurality of targets on the tractor.

Embodiment 12: The method of any one of Embodiment 1 through Embodiment 11, wherein the implement has a dimension different from a dimension of the another implement, the dimension selected from the group consisting of a longitudinal distance from the hitch to a row unit carried by the implement, a lateral distance from the hitch to a row unit carried by the implement, a longitudinal distance from the hitch to a centerline of an axle of the implement, a lateral distance from the hitch to a centerline of a wheel assembly of the implement, and a lateral spacing between adjacent row units of the implement.

Embodiment 13: A non-transitory computer-readable storage medium including instructions that when executed by a computer, cause the computer to receive a plurality of signals from satellites at a global positioning system (GPS) receiver carried by a tractor; determine a location within a field of the GPS receiver based on the signals from the satellites; determine an orientation with respect to the tractor of an implement towed by the tractor. The implement includes a toolbar and a hitch, and the hitch is configured to be coupled to a drawbar of the tractor. The instructions further cause the computer to determine, based at least in part on the location of the GPS receiver and the orientation of the implement, a location within the field of at least one point on the implement in addition to a location of the hitch; and steer the tractor to direct the implement along a selected path previously traversed by another implement within the field.

Embodiment 14: A system for determining a location of an implement including a tractor having a drawbar; an implement comprising a toolbar and a hitch, the hitch coupled to the drawbar such that the implement is configured to rotate about a connection between the hitch and the drawbar when the implement is pulled by the tractor; a GPS receiver carried by the tractor or the implement; at least one camera configured to detect a position of the implement relative to the tractor; and a monitor in signal connection with the GPS receiver and the at least one camera. The monitor is configured to determine a location within a field of at least one point on the implement.

Embodiment 15: The system of Embodiment 14, further comprising at least one target visible to the at least one camera.

Embodiment 16: The system of Embodiment 14 or Embodiment 15, wherein the camera is fixed with respect to the tractor.

Embodiment 17: The system of Embodiment 14 or Embodiment 15, wherein the camera is fixed with respect to the implement.

Embodiment 18: The system of any one of Embodiment 14 through Embodiment 17, wherein the system comprises only one GPS receiver.

Embodiment 19: A system for determining a location of an implement including a tractor having a drawbar; an implement comprising a toolbar and a hitch, the hitch coupled to the drawbar such that the implement is configured to rotate about a connection between the hitch and the drawbar when the implement is pulled by the tractor; a GPS receiver carried by the tractor or the implement; at least one sensor configured to detect a position of the implement relative to the tractor; and a monitor in signal connection with the GPS receiver and the at least one sensor. The monitor is configured to determine a location within a field of at least one point on the implement.

Embodiment 20: The system of Embodiment 19, wherein the at least one sensor comprises at least one sensor selected from the group consisting of 3-axis magnetometers and 3-axis gyroscopes.

Embodiment 21: The system of Embodiment 19 or Embodiment 20, wherein the at least one sensor comprises a first sensor fixed with respect to the tractor and a second sensor fixed with respect to the implement.

Embodiment 22: The system of any one of Embodiment 19 through Embodiment 21, wherein the at least one sensor comprises a plurality of radio frequency transceivers, wherein at least a first transceiver is fixed with respect to the tractor and at least a second transceiver is fixed with respect to the implement.

Embodiment 23: The system of any one of Embodiment 19 through Embodiment 22, wherein the at least one sensor comprises a rotary encoder configured to measure rotation of the hitch with respect to the drawbar.

Embodiment 24: The system of any one of Embodiment 19 through Embodiment 23, wherein the at least one sensor comprises at least one camera.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various implement types and configurations.

1. A method of working a field, the method comprising:
receiving a plurality of signals from satellites at a global positioning system (GPS) receiver carried by a tractor;
determining a location within a field of the GPS receiver based on the signals from the satellites;
determining an orientation with respect to the tractor of an implement towed by the tractor, the implement comprising a toolbar and a hitch, the hitch coupled to a drawbar of the tractor;
determining, based at least in part on the location of the GPS receiver and the orientation of the implement, a location within the field of at least one point on the implement in addition to a location of the hitch; and
steering the tractor to direct the implement along a selected path previously traversed by another implement within the field.

2. The method of claim 1, further comprising determining, based at least in part on the location of the GPS receiver, a location within the field of a point at which the hitch pivots with respect to the drawbar.

3. The method of claim 1, wherein determining an orientation with respect to the tractor of an implement towed by the tractor comprises measuring Euler angles with respect to the Earth of each of the tractor and the implement.

4. The method of claim 3, wherein measuring Euler angles with respect to the Earth of each of the tractor and the implement comprises measuring a yaw, pitch, and roll of each of the tractor and the implement.

5. The method of claim 1, wherein determining an orientation with respect to the tractor of an implement towed by the tractor comprises measuring a distance from a point on the tractor to a point on the implement.

6. The method of claim 5, wherein measuring a distance from a point on the tractor to a point on the implement comprises measuring a plurality of distances from a point on the tractor to a plurality of points on the implement.

7. The method of claim 1, wherein determining an orientation with respect to the tractor of an implement towed by the tractor comprises measuring relative movement of the hitch with respect to the drawbar.

8. The method of claim 7, wherein measuring relative movement of the hitch with respect to the drawbar comprises measuring rotary movement about three perpendicular axes.

9. The method of claim 1, wherein determining an orientation with respect to the tractor of an implement towed by the tractor comprises capturing an image of a plurality of targets.

10. The method of claim 9, wherein capturing an image of a plurality of targets comprises capturing, with a camera mounted at a fixed point with respect to the tractor, an image of a plurality of targets on the implement.

11. The method of claim 9, wherein capturing an image of a plurality of targets comprises capturing, with a camera mounted at a fixed point with respect to the implement, an image of a plurality of targets on the tractor.

12. The method of claim 1, wherein the implement has a dimension different from a dimension of the another implement, the dimension selected from the group consisting of a longitudinal distance from the hitch to a row unit carried by the implement, a lateral distance from the hitch to a row unit carried by the implement, a longitudinal distance from the hitch to a centerline of an axle of the implement, a lateral distance from the hitch to a centerline of a wheel assembly of the implement, and a lateral spacing between adjacent row units of the implement.

13. A non-transitory computer-readable storage medium, the computer-readable storage medium including instructions that when executed by a computer, cause the computer to:
receive a plurality of signals from satellites at a global positioning system (GPS) receiver carried by a tractor;
determine a location within a field of the GPS receiver based on the signals from the satellites;
determine an orientation with respect to the tractor of an implement towed by the tractor, the implement comprising a toolbar and a hitch, the hitch coupled to a drawbar of the tractor;
determine, based at least in part on the location of the GPS receiver and the orientation of the implement, a location within the field of at least one point on the implement in addition to a location of the hitch; and
steer the tractor to direct the implement along a selected path previously traversed by another implement within the field.

14. A system for determining a location of an implement, the system comprising:
a tractor having a drawbar;
an implement comprising a toolbar and a hitch, the hitch coupled to the drawbar such that the implement is configured to rotate about a connection between the hitch and the drawbar when the implement is pulled by the tractor;
a GPS receiver carried by the tractor or the implement;
at least one camera configured to detect a position of the implement relative to the tractor; and
a monitor in signal connection with the GPS receiver and the at least one camera, the monitor configured to determine a location within a field of at least one point on the implement.

15. The system of claim 14, further comprising at least one target visible to the at least one camera.

16. The system of claim 14, wherein the camera is fixed with respect to the tractor.

17. The system of claim 14, wherein the camera is fixed with respect to the implement.

18. The system of claim 14, wherein the system comprises only one GPS receiver.
